(19) United States
(12) Patent Application Publication
(10) Pub. No.: US 2019/0136816 A1
(43) Pub. Date: May 9, 2019

(54) VEHICLE IGNITION ON A SCHEDULE

(71) Applicant: Panasonic Automotive Systems Company of America, Division of Panasonic Corporation of North America, Peachtree City, GA (US)

(72) Inventors: JENAT AWAD, FARMINGTON HILLS, MI (US); DANIEL D. WILCOX, FARMINGTON HILLS, MI (US)

(73) Assignee: Panasonic Automotive Systems Company of America, Division of Panasonic Corporation of North America

(21) Appl. No.: 16/180,284

(22) Filed: Nov. 5, 2018

Related U.S. Application Data
(60) Provisional application No. 62/582,649, filed on Nov. 7, 2017.

(51) Int. Cl. F02N 11/08; B60H 1/00; B60W 10/06; B60W 10/30; B60W 30/00

(52) U.S. Cl. CPC F02N 11/0811; B60H 1/00892; B60H 1/00735; B60W 10/06; B60W 2710/30; B60W 30/00; F02N 2300/306; B60W 2600/00; B60W 10/30

(57) ABSTRACT

A motor vehicle includes an engine ignition system for starting an engine of the motor vehicle. A climate control system heats and/or cools a passenger compartment of the motor vehicle. An electronic processor is communicatively coupled to the engine ignition system and to the climate control system. The electronic processor determines a time at which a user of the motor vehicle will enter a passenger compartment of the motor vehicle, uses the engine ignition system to start the engine before the determined time, and uses the climate control system to achieve a desired temperature of the passenger compartment before the user enters the passenger compartment.

### CROSS-REFERENCED TO RELATED APPLICATIONS

This application claims benefit of U.S. Provisional Application No. 62/582,649 filed on Nov. 7, 2017, which the disclosure of which is hereby incorporated by reference in its entirety for all purposes.

### FIELD OF THE INVENTION

The disclosure relates to operating a vehicle ignition system and accessories in a motor vehicle.

### BACKGROUND OF THE INVENTION

Getting into a cold car in the winter or a hot car in the summer can be an unpleasant experience. In the summer, minor burns can occur, especially to those with exposed skin. Currently, a manual start/stop of a vehicle's engine by use of a key fob or an APP exists.

### SUMMARY

According to the present invention, a vehicle may be set to a specific schedule to turn on its accessories such as radio settings, seat heating/cooling settings, and other comfort settings. Using sensors, the vehicle may turn itself off (e.g., turn off the ignition) if the engine is running to reduce carbon monoxide exposure. The vehicle may autonomously drive itself in order to pick up the vehicle owner based on an app request or a pre-set schedule. The vehicle may park itself and send a notification to the vehicle owner upon completing the parking operation.

The vehicle may be started and comfort settings may be executed based on a request from the APP. However, instead of using an APP for a mobile device such as Android or Apple platforms, the schedule can alternatively be entered into the onboard computer system or on the web.

By automatically activating predetermined climate controls, the comfort of passengers may be increased, and the risk of burns can be avoided or minimized. Also, vehicles can autonomously drive to customers to pick them up, which improves safety.

Additional sensors can be used to monitor carbon monoxide buildup. If the carbon monoxide buildup becomes too great, then the engine may be turned off in order to stop the production of carbon monoxide.

In one embodiment, the invention comprises a motor vehicle including an engine ignition system for starting an engine of the motor vehicle. A climate control system heats and/or cools a passenger compartment of the motor vehicle. An electronic processor is communicatively coupled to the engine ignition system and to the climate control system. The electronic processor determines a time at which a user of the motor vehicle will enter a passenger compartment of the motor vehicle, uses the engine ignition system to start the engine before the determined time, and uses the climate control system to achieve a desired temperature of the passenger compartment before the user enters the passenger compartment.

In another embodiment, the invention comprises a method for operating a motor vehicle, including providing an engine ignition system for starting an engine of the motor vehicle. A climate control system is provided for heating and/or cooling a passenger compartment of the motor vehicle. A time at which a user of the motor vehicle plans to enter a passenger compartment of the motor vehicle is determined. The engine ignition system is used to start the engine before the determined time. The climate control system is used to achieve a desired temperature of the passenger compartment before the user enters the passenger compartment.

In yet another embodiment, the invention comprises a motor vehicle, including a climate control system for heating and/or cooling a passenger compartment of the motor vehicle. An electronic processor is communicatively coupled the climate control system. The electronic processor retrieves information from a user's personal electronic calendar, and determines from the retrieved information a time at which a user of the motor vehicle plans to enter a passenger compartment of the motor vehicle. The electronic processor uses the climate control system to achieve a desired temperature of the passenger compartment before the user enters the passenger compartment.

The present invention may enable comfort controls to be implemented for those users on a highly predictable schedule, such as for work and school.

### BRIEF DESCRIPTION OF THE DRAWINGS

A better understanding of the present invention will be had upon reference to the following description in conjunction with the accompanying drawings.

FIG. 1 is a block diagram of one embodiment of a vehicle management arrangement of the present invention.

FIG. 2 is a flow chart of one embodiment of a method of the present invention for operating a motor vehicle.

### DETAILED DESCRIPTION OF THE PREFERRED EMBODIMENTS

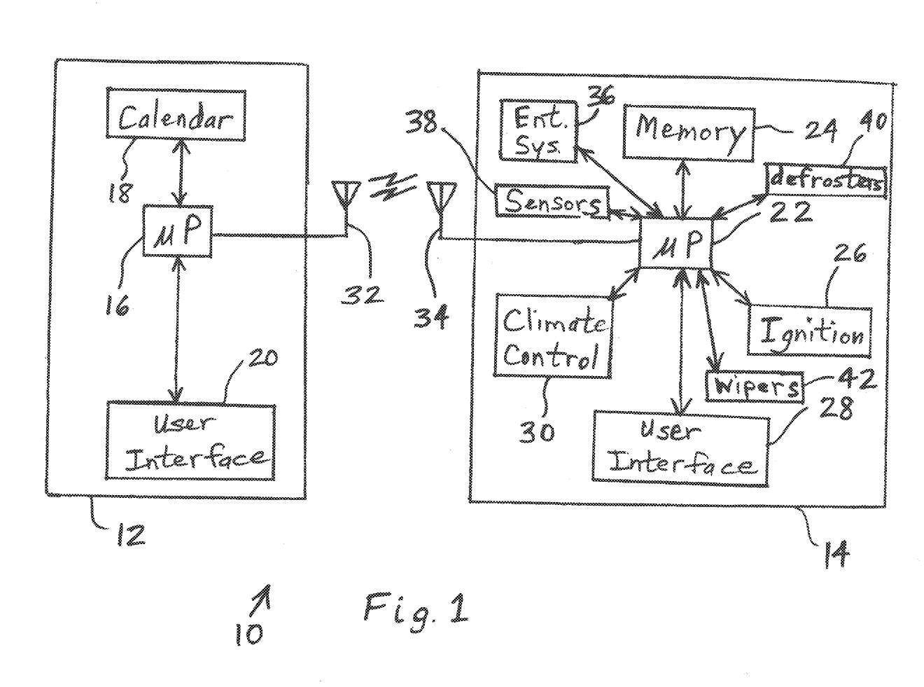

FIG. 1 illustrates one embodiment of a vehicle management arrangement 10 of the present invention, including a personal electronic device 12 and a motor vehicle 14. Personal electronic device 12 may be a mobile telephone, and may include an electronic processor 16 in bi-directional communication with each of an electronic calendar 18 and a user interface 20. Motor vehicle 14 may include an electronic processor 22 in bi-directional communication with each of a memory device 24, an engine ignition system 26, a user interface 28, a climate control system 30, an infotainment system 36 and sensors 38.

During use, processor 16 may retrieve a user's calendar 18 and transmit calendar 18 to processor 22 via antennae 32, 34. Processor 22 may analyze calendar 18 to determine when the user will be using vehicle 14. Processor 22 may then prepare vehicle 14 so that vehicle 14 is in optimal condition for use at the time that the user begins using vehicle 14. For example, processor 22 may send a signal to ignition system 26 to start the vehicle's engine so that the engine will be running when the user is ready to use vehicle 14. If vehicle 14 is to be autonomously driven to pick up the user, then the engine may be started at a time that allows for travel time of vehicle 14 before the user is picked up. If vehicle 14 is to remain parked before the user enters vehicle 14, then processor 22 may determine whether the heater or air conditioner of climate control system 30 needs to be operated in order to make the passenger compartment of vehicle 14 comfortable for the user when he enters it.

Processor 22 may receive temperature readings from a temperature sensor associated with the passenger compartment, and may start the engine and begin operating climate control system 30 dependent upon the temperature readings. For example, processor 22 may begin heating or cooling the passenger compartment in time to achieve a desired comfortable temperature (e.g., 72 degrees Fahrenheit) before the user is to enter the passenger compartment. Climate control system 30 may also include a seat heating and/or cooling system such that processor 22 may set the driver's seat and/or passenger seat to a desired temperature by the time the driver and/or passenger enter the passenger compartment.

Processor 22 may store the user's calendar in memory device 24 so that the vehicle can be similarly prepared for other trips by the user in the future. The user may indicate on his calendar what time he will need the vehicle on each day.

Instead of, or in addition to, the use of calendar 18 to determine when the user will need the vehicle, the user may communicate via user interface 20 when he would like to use the vehicle. For example, user interface 20 may include a microphone into which the user may speak when he would like to use the vehicle. User interface 20 may also include a keyboard which the user may use to enter a time schedule for when he plans to use the vehicle. The user may also use the microphone or keyboard to enter a desired passenger compartment temperature at the time he enters the passenger compartment.

Processor 22 may also receive signals from vehicle humidity sensors or moisture sensors among sensors 38, and processor 22 may automatically operate vehicle defrosters 40 and windshield wipers 42 based on these signals in order to make the vehicle safe to drive as soon as the user enters the passenger compartment. Processor 22 may further receive signals from carbon monoxide sensors among sensors 38, and processor 22 may automatically turn off the ignition system 26 so as to stop producing carbon monoxide if the carbon monoxide level is detected as being too high.

Processor 22 may also implement any preferences of the particular driver for whom the vehicle is being prepared, such as mirror orientations and seat positions. Processor 22 may also implement any infotainment preferences of the driver, such as tuning the radio to a radio station that the user is known to listen to at the particular time of day.

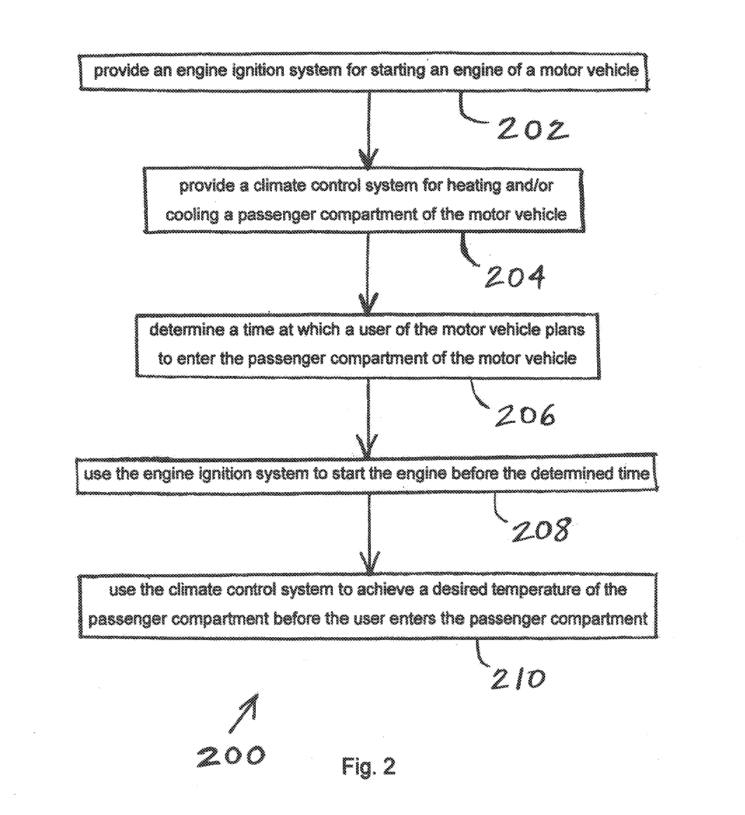

FIG. 2 illustrates one embodiment of a method 200 of the present invention for operating a motor vehicle. In a first step 201 an engine ignition system for starting an engine of the motor vehicle is provided. For example, vehicle 14 may be provided with ignition system 26 for starting an engine of vehicle 14.

In a next step 204, a climate control system for heating and/or cooling a passenger compartment of the motor vehicle is provided. For example, vehicle 14 may be provided with climate control system 30 for heating and/or cooling a passenger compartment of motor vehicle 14.

Next, in step 206, a time at which a user of the motor vehicle plans to enter the passenger compartment of the motor vehicle is determined. For example, processor 22 may analyze calendar 18 to determine when the user will be using vehicle 14.

In step 208, the engine ignition system is used to start the engine before the determined time. For example, processor 22 may send a signal to ignition system 26 to start the vehicle's engine before the time when the user will be using vehicle 14 so that the engine will be running when the user is ready to use vehicle 14.

In a final step 210, the climate control system is used to achieve a desired temperature of the passenger compartment before the user enters the passenger compartment. For example, processor 22 may determine whether the heater or air conditioner of climate control system 30 needs to be operated before the user enters the passenger compartment of vehicle 14 in order to make the passenger compartment a comfortable temperature for the user when he enters it.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
an engine ignition system configured to start an engine of the motor vehicle;
a climate control system configured to heat and/or cool a passenger compartment of the motor vehicle; and
an electronic processor communicatively coupled to the engine ignition system and to the climate control system, the electronic processor being configured to:
determine a time at which a user of the motor vehicle plans to enter the passenger compartment of the motor vehicle;
use the engine ignition system to start the engine before the determined time; and
use the climate control system to achieve a desired temperature of the passenger compartment before the user enters the passenger compartment.

2. The motor vehicle of claim 1 further comprising:
a moisture sensor or a humidity sensor; and
a windshield defroster, wherein the electronic processor is configured to use the windshield defroster to defrost a windshield before the user enters the passenger compartment, the defrosting being dependent upon a signal from the moisture sensor or humidity sensor.

3. The motor vehicle of claim 1 further comprising:
a moisture sensor or a humidity sensor; and
a windshield wiper, wherein the electronic processor is configured to use the windshield wiper to wipe a windshield before the user enters the passenger compartment, the wiping being dependent upon a signal from the moisture sensor or humidity sensor.

4. The motor vehicle of claim 1 further comprising an infotainment system, wherein the electronic processor is configured to use the infotainment system to play a selection desired by the user when the user enters the passenger compartment.

5. The motor vehicle of claim 4 wherein the selection comprises a radio station.

6. The motor vehicle of claim 4 wherein the selection comprises a genre of music.

7. The motor vehicle of claim 1 wherein the electronic processor is configured to determine a time at which a user of the motor vehicle plans to enter a passenger compartment of the motor vehicle by accessing a personal calendar of the user in a personal electronic device of the user.

8. A method for operating a motor vehicle, the method comprising:
providing an engine ignition system for starting an engine of the motor vehicle;
providing a climate control system for heating and/or cooling a passenger compartment of the motor vehicle;
determining a time at which a user of the motor vehicle plans to enter the passenger compartment of the motor vehicle;
using the engine ignition system to start the engine before the determined time; and
using the climate control system to achieve a desired temperature of the passenger compartment before the user enters the passenger compartment.

9. The method of claim 8 further comprising:
providing a moisture sensor or a humidity sensor;
receiving a signal from the moisture sensor or humidity sensor;
providing a windshield defroster
using the windshield defroster to defrost a windshield before the user enters the passenger compartment, the defrosting being dependent upon the signal from the moisture sensor or humidity sensor.

10. The method of claim 8 further comprising:
providing a moisture sensor or a humidity sensor;
receiving a signal from the moisture sensor or humidity sensor;
providing a windshield wiper; and
using the windshield wiper to wipe a windshield before the user enters the passenger compartment, the wiping being dependent upon the signal from the moisture sensor or humidity sensor.

11. The method of claim 8 further comprising:
providing an infotainment system; and
using the infotainment system to play a selection desired by the user when the user enters the passenger compartment.

12. The method of claim 11 wherein the selection comprises a radio station.

13. The method of claim 11 wherein the selection comprises a genre of music.

14. The method of claim 8 wherein the determining step includes determining a time at which a user of the motor vehicle plans to enter a passenger compartment of the motor vehicle by accessing a personal calendar of the user in a personal electronic device of the user.

15. A motor vehicle, comprising:
a climate control system configured to heat and/or cool a passenger compartment of the motor vehicle; and
an electronic processor communicatively coupled the climate control system, the electronic processor being configured to:
retrieve information from a user's personal electronic calendar;
determine from the retrieved information a time at which a user of the motor vehicle plans to enter a passenger compartment of the motor vehicle; and
use the climate control system to achieve a desired temperature of the passenger compartment before the user enters the passenger compartment.

16. The motor vehicle of claim 15, further comprising an engine ignition system communicatively coupled to the electronic processor and configured to start an engine of the motor vehicle, the electronic processor being configured to use the engine ignition system to start the engine before the determined time.

17. The motor vehicle of claim 15 further comprising:
a moisture sensor or a humidity sensor; and
a windshield defroster, wherein the electronic processor is configured to use the windshield defroster to defrost a windshield before the user enters the passenger compartment, the defrosting being dependent upon a signal from the moisture sensor or humidity sensor.

18. The motor vehicle of claim 15 further comprising:
a moisture sensor or a humidity sensor; and
a windshield wiper, wherein the electronic processor is configured to use the windshield wiper to wipe a windshield before the user enters the passenger compartment, the wiping being dependent upon a signal from the moisture sensor or humidity sensor.

19. The motor vehicle of claim 15 further comprising an infotainment system, wherein the electronic processor is configured to use the infotainment system to play a selection desired by the user when the user enters the passenger compartment.

20. The motor vehicle of claim 19 wherein the selection comprises a radio station.

21. The motor vehicle of claim 19 wherein the selection comprises a genre of music.
